(19) United States
(12) Patent Application Publication
(10) Pub. No.: US 2023/0010132 A1
(43) Pub. Date: Jan. 12, 2023

(54) GLASS SUBSTRATE JOINING METHOD

(71) Applicant: CORNING INCORPORATED, Corning, NY (US)

(72) Inventors: Ying Liu, Painted Post, NY (US); Craig John Mancusi Ungaro, Corning, NY (US)

(21) Appl. No.: 17/847,620

(22) Filed: Jun. 23, 2022

Related U.S. Application Data
(60) Provisional application No. 63/217,943, filed on Jul. 2, 2021.

(51) Int. Cl. C03B 23/203

(52) U.S. Cl. CPC C03B 23/203

(57) ABSTRACT

A method of joining glass substrates is disclosed. The method positions a first glass substrate onto a translational stage and a second glass substrate onto the first glass substrate. In some examples, a gap is defined by contact made between the first and second glass substrates. In such examples, the gap can be up to about 10 μm. Additionally, in such examples, the method includes focusing a beam of light within the first glass substrate proximate to the gap. Further, in such examples, the method includes joining the first and second glass substrates to one another in a manner that closes the gap as a result of the focusing of the beam of light within the first glass substrate. In various examples, the first and second glass substrates each exhibit a transmittance of at least about 90% at a wavelength of the beam of light.

This application claims the benefit of priority under 35 U.S.C § 120 of U.S. Provisional Application Ser. No. 63/217,943 filed on Jul. 2, 2021, the content of which is relied upon and incorporated herein by reference in its entirety.

### BACKGROUND

The present invention generally relates to a method for joining glass substrates to one another.

### SUMMARY

According to one example, a method of joining glass substrates includes coupling a first glass substrate to a second glass substrate, wherein the first glass substrate includes a first bottom surface and a first top surface that is opposite to the first bottom surface. The second glass substrate is positioned onto the first glass substrate such that a second bottom surface of the second glass substrate and the first top surface of the first glass substrate are in direct contact with one another. The direct contact between the first and second glass substrates establishes an interface between the first glass substrate and the second glass substrate. The interface between the first glass substrate and the second glass substrate defines a gap with a height that extends between the first top surface and the second bottom surface. The height of the gap can be up to about 10 μm. The method also includes positioning the first glass substrate onto a translational stage. The first bottom surface of the first glass substrate is proximate to the translational stage. The method further includes focusing a beam of light within the first glass substrate proximate to the gap. The method also includes joining the first and second glass substrates to one another in a manner that closes the gap as a result of the focusing of the beam of light within the first glass substrate.

In various aspects of the first example, the first glass substrate can have a first coefficient of thermal expansion and the second glass substrate has a second coefficient of thermal expansion, with the first and second coefficients of thermal expansion differing by up to about 9 ppm/° C. In some examples, the first and second glass substrates can each exhibit a transmittance of at least about 90% at a wavelength of the beam of light. In various examples, the step of joining the first and second glass substrates to one another in a manner that closes the gap as a result of the focusing of the beam of light within the first glass substrate can include inducing an increase in temperature of a localized volume of the first glass substrate and the second glass substrate as a result of the focusing a beam of light within the first glass substrate proximate to the gap, with the localized volume including at least one area chosen from a plasma region and a heat-affected zone, and wherein the plasma region reaches a temperature sufficient to melt portions of the first and second glass substrates located within the plasma region. In such examples, the method can also include solidifying the melted portions of the first and second glass substrates located within the plasma region. In various examples, heat is accumulated within the first and second glass substrates as a result of the induced increase in temperature of a localized volume of the first glass substrate and the second glass substrate, with the heat that is accumulated being dissipated to a temperature below about 1,000° C. over a timeframe of between about 1 millisecond and about 30 milliseconds following exposure to the beam of light. In some examples, the method can also include adjusting a position of the translational stage along a first axis such that the first glass substrate and the second glass substrate are moved relative to the beam of light, thereby propagating the joining of the first and second glass substrates to one another. In various examples, the method can include rastering the beam of light back-and-forth along a second axis such that a position of the beam of light is moved relative to the first glass substrate and the second glass substrate, with the first axis and the second axis being angularly offset from one another. In some examples, the beam of light focused within the first glass substrate proximate to the gap can be from a pulsed laser, with the rastering of the beam of light back-and-forth along a second axis such that a position of the beam of light is moved relative to the first glass substrate and the second glass substrate resulting in a pulse overlap between sequential pulses from the pulsed laser to define a weld line, and wherein the pulse overlap is up to about 99%. In various examples, the adjusting of a position of the translational stage along a first axis such that the first glass substrate and the second glass substrate are moved relative to the beam of light results in a line overlap between adjacent weld lines, with the line overlap being up to about 99%. In some examples, the first axis and the second axis are angularly offset from one another by up to about ninety degrees. In various examples, a focal point of the beam of light can have a diameter that is up to about 10 μm. In some examples, the method can include positioning the focal point of the beam of light between about 40 μm and about 90 μm away from the interface between the first and second glass substrates.

According to another example, a method of joining glass substrates includes coupling a first glass substrate to a second glass substrate. The first glass substrate includes a first bottom surface and a first top surface that is opposite to the first bottom surface. The second glass substrate is positioned onto the first glass substrate such that a second bottom surface of the second glass substrate and the first top surface of the first glass substrate are in direct contact with one another. The direct contact between the first and second glass substrates establishes an interface between the first glass substrate and the second glass substrate. The method also includes positioning the first glass substrate onto a translational stage. The first bottom surface is proximate to the translational stage. The method further includes focusing a beam of light within the first glass substrate proximate to the interface between the first glass substrate and the second glass substrate. The first and second glass substrates can each exhibit a transmittance of at least about 90% at a wavelength of the beam of light. The method also includes inducing an increase in temperature of a localized volume of the first glass substrate and the second glass substrate as a result of the focusing a beam of light within the first glass substrate proximate to the interface between the first glass substrate and the second glass substrate. The localized volume includes at least one area chosen from a plasma region and a heat-affected zone. The plasma region can reach a temperature sufficient to melt portions of the first and second glass substrates located within the plasma region. The method further includes solidifying the melted portions of the first and second glass substrates located within the plasma region. The method also includes joining the first and second glass substrates as a result of the melting and solidifying of the portions of the first and second glass substrates located within the plasma region.

According to various aspects of the second example, the interface between the first glass substrate and the second glass substrate can define a gap with a height that extends between the first top surface and the second bottom surface, with the height of the gap being up to about 10 μm. In some examples, the first glass substrate can have a first coefficient of thermal expansion and the second glass substrate can have a second coefficient of thermal expansion, with the first and second coefficients of thermal expansion differing by up to about 9 ppm/° C. In various examples, heat is accumulated within the first and second glass substrates as a result of the induced increase in temperature of a localized volume of the first glass substrate and the second glass substrate, with the heat that is accumulated being dissipated to a temperature below about 1,000° C. over a timeframe of between about 1 millisecond and about 30 milliseconds following exposure to the beam of light. In some examples, the method also includes adjusting a position of the translational stage along a first axis such that the first glass substrate and the second glass substrate are moved relative to the beam of light, thereby propagating the joining of the first and second glass substrates to one another. In such examples, the method can further include rastering the beam of light back-and-forth along a second axis such that a position of the beam of light is moved relative to the first glass substrate and the second glass substrate, with the first axis and the second axis are angularly offset from one another by up to about ninety degrees. In various examples, the beam of light focused within the first glass substrate proximate to the gap is from a pulsed laser, with the rastering of the beam of light back-and-forth along a second axis such that a position of the beam of light is moved relative to the first glass substrate and the second glass substrate resulting in a pulse overlap between sequential pulses from the pulsed laser to define a weld line, and wherein the pulse overlap is up to about 99%. In some examples, the adjusting of a position of the translational stage along a first axis such that the first glass substrate and the second glass substrate are moved relative to the beam of light results in a line overlap between adjacent weld lines, with the line overlap being up to about 99%. In various examples, the method can include positioning a focal point of the beam of light between about 40 μm and about 90 μm away from the interface between the first and second glass substrates, with the focal point of the beam of light having a diameter that is up to about 10 μm.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a schematic view of a glass substrate joining system, illustrating various components thereof, according to one example;

FIG. 2A is an end view of a first glass substrate, illustrating channels etched therein;

FIG. 2B is a top perspective view of the first glass substrate with a second glass substrate positioned thereupon, illustrating a light traversing the first and second glass substrates, according to one example;

FIG. 2C is an end view along an X-Z plane of the first and second glass substrates, illustrating a weld line joining the first and second glass substrates to one another;

FIG. 2D is an end view along a Y-Z plane of the first and second glass substrates, illustrating varied depths of the light within the first glass substrate;

FIG. 3 is an expanded view of a gap between the first and second glass substrates, illustrating a plasma region and a heat-affected zone of the light closing the gap;

FIG. 4 is a plot of energy deposition versus a structure width of the plasma region and the heat-affected zone;

FIG. 5 is a plot of energy deposition versus a size of the weld line in a length dimension and a width dimension;

FIG. 6 is a schematic of the first and second glass substrates, illustrating varied depths of focus that were investigated for establishing the weld lines;

FIG. 7 is a schematic representation of a crack opening test, illustrating a knife being inserted between the first and second glass substrates after joining;

FIG. 8 is a plot of pulse energy versus crack distance and bonding energy, illustrating a crack distance and a bonding energy that was observed during the crack opening test;

FIG. 9 is a plot of focal position of the light versus crack distance and bonding energy, illustrating a crack distance and a bonding energy that was observed during the crack opening test;

FIG. 10 illustrates a tensile strength test where the first and second glass substrates are adhered to first and second fixtures, respectively;

FIG. 11 is a plot of pulse energy versus bonding strength, as determined by the tensile strength test;

FIG. 12 is a schematic view of the glass substrate joining system, illustrating various components thereof, according to another example;

FIG. 13 is an illustration of a low-speed welding process;

FIG. 14 is an illustration of an on-the-fly welding process;

FIG. 15 is a plot of a simulated temporal temperature evolution for the low-speed welding process;

FIG. 16 is a plot of a simulated a temporal temperature evolution for the on-the-fly welding process;

FIG. 17 is a bar graph illustrating a fracture toughness, as measured by the crack opening test, for various joined glass combinations;

FIG. 18 is a flow chart illustrating a method of joining glass substrates, according to one example; and

FIG. 19 is a flow chart illustrating a method of joining glass substrates, according to another example.

### DETAILED DESCRIPTION

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

Reference will now be made in detail to the present preferred embodiments, examples of which are illustrated in the accompanying drawings. Whenever possible, the same reference numerals will be used throughout the drawings to refer to the same or like parts.

Glass-to-glass welding with high bonding strength and optical transparency at micro-scale can be useful in a variety of industrial fields, such as micro-optics and photonics, micro/nanoelectromechanical systems (MEMS/NEMS), glass packing, glass sealing, and glass repairing. Several established technologies for glass bonding include optical contacting, gluing, soldering, diffusion bonding, glass frit bonding, carbon dioxide (CO₂) laser welding, and laser welding with an absorbing layer positioned between two glass substrates. In general, bonding methods without the use of additives include optical contact, thermal diffusion bonding, and CO₂ laser welding. However, each method has specific properties that limit its application range. For example, optical contacting is limited to weak bonding strength, thermal diffusion bonding involves high pressures and thermal treatment, and CO₂ laser welding highly depends on glass absorption. In comparison, bonding methods that use additional materials, including gluing, soldering, glass frit bonding, and laser welding with an absorbing layer, often suffer from a mismatch of thermal expansion coefficients, as well as reduced optical transparency and increased cost. To overcome the limitations of the above-mentioned methods, it is necessary to bond glass samples directly without applying any adhesive or other non-glass materials at an interface between the glass samples.

By contrast, the ultrafast laser welding techniques disclosed herein are a promising technique for fusion welding of glass due to its highly localized heat-affected zone and the ability to directly join glass without the use of an absorbing layer. Ultrafast laser welding is a direct and space-selective bonding method using nonlinear absorption. First, an ultrafast pulsed laser with high intensity was guided to irradiate inside transparent glass substrates. At a focal point of a beam from the laser, when the intensity is high enough (e.g., at least 10¹² W/cm²), multiphoton absorption occurs and is followed by subsequent avalanche ionization. The energy that results from this type of ionization is transferred efficiently into the bulk material of the glass substrate(s) and can lead to a variety of modifications of the glass substrate(s), depending on what processing parameters are employed. Additionally, a heat accumulation effect is harnessed by increasing a repetition rate of the ultrafast laser (e.g., 100's of kHz), which leads to a local temperature that exceeds a melting temperature of the glass substrate(s). This heat accumulation results in more efficient energy absorption and increases a physical size of the heat-affected zone.

As will be discussed in further detail herein, various examples of the glass-to-glass welding discussed in the present disclosure involved stacking two pieces of pre-cleaned glass substrates, mechanically pressing the glass substrates together to eliminate an air gap that naturally exists between adjacent surfaces, adjusting the position of the focal point relative to an interface between the glass substrates, and adopting a fast, discrete line scan or a close-loop/serpentine scan based on a required sealing area. To avoid ablation and cracks at the glass substrate interface, a proper close contact, also known as optical contact, is usually employed. Such close contact can be achieved by pressing two flat, smooth, and clean glass surfaces together using mechanical clamping systems. The glass substrates typically have a roughness that is about 2 nm or less and a flatness that is about 125 nm or less. However, the use of optical contact and a mechanical clamping system represents a significant barrier to realize the application of ultrafast laser welding in industrial mass production. It is intrinsically difficult to achieve optical contact over a large area with low cost, due to the requirement of high surface quality and rigorous cleaning processes. Furthermore, using mechanical clamping systems can introduce internal stress within the glass substrates, causing the glass substrates to be more susceptible to undesirable cracks during the welding or joining process.

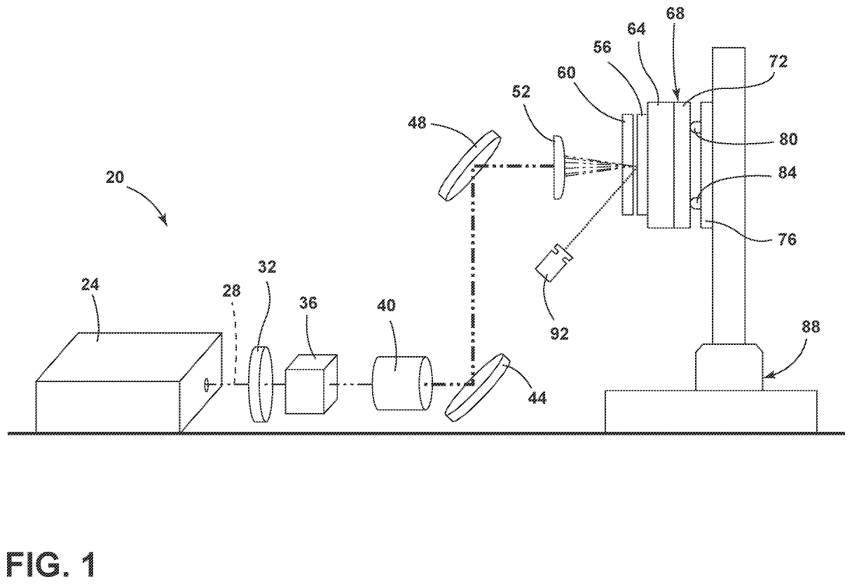

Referring to FIG. 1, reference numeral 20 generally designates an exemplary substrate joining system. The substrate joining system 20 includes a light source 24 that emits light 28. In one specific example, the light source 24 is a picosecond pulsed laser. The light 28 emitted from the light source 24 passes through a half-wave plate 32, a beam splitter 36, and a beam expander 40 on its way to a first mirror 44. The light 28 emitted from the light source 24 is directed to a second mirror 48 by the first mirror 44. From the second mirror 48, the light 28 is directed to a focusing lens 52. In one specific example, the focusing lens 52 has a numerical aperture of 17 mm and a focal length of 30 mm. The focusing lens 52 is employed to focus the light 28 from the light source 24 onto a first glass substrate 56 and/or a second glass substrate 60. The first glass substrate 56 is positioned on a vacuum chuck 64. The vacuum chuck 64 is supported by a tilt platform 68 that can be employed to adjust an angular relationship between the light 28 and the first glass substrate 56 and/or the second glass substrate 60. The tilt platform 68 can include a first portion 72 and a second portion 76. The first portion 72 can be coupled to the second portion 76 by a first adjustable member 80 and a second adjustable member 84. In various examples, a distance between the first portion 72 and the second portion 76 can be changed by adjusting the first adjustable member 80 and/or the second adjustable member 84. For example, the first and second adjustable members 80, 84 may be threaded fasteners that can be rotated to adjust an angular orientation of the first portion 72, which in turn can adjust an angular orientation of the vacuum chuck 64, the first glass substrate 56, and/or the second glass substrate 60 relative to the light 28. The tilt platform 68 is coupled to a translational stage 88. The translational stage 88 can be an X-Y-Z linear translational stage. A camera 92 is utilized to observe the light 28, the first glass substrate 56, and/or the second glass substrate 60 when positioning a focal point of the light 28 coming from the focusing lens 52 and to monitor the joining process.

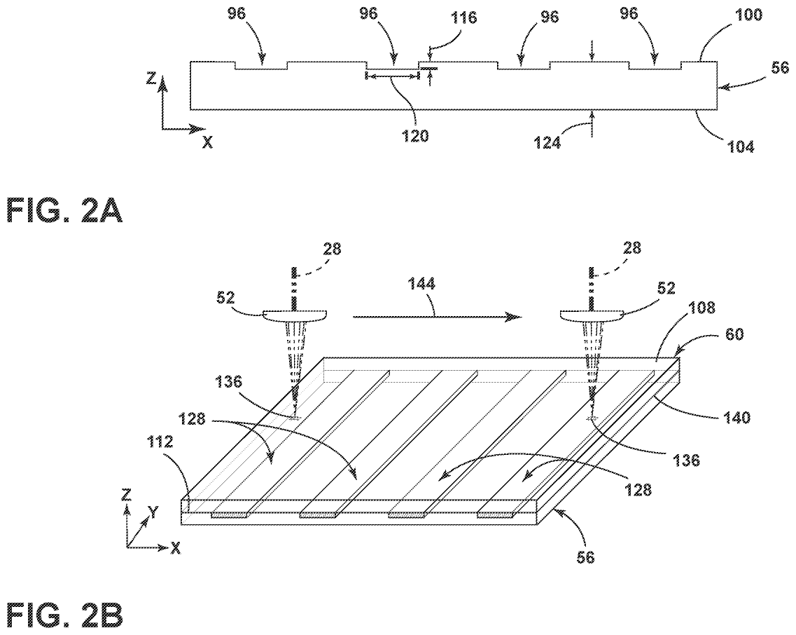

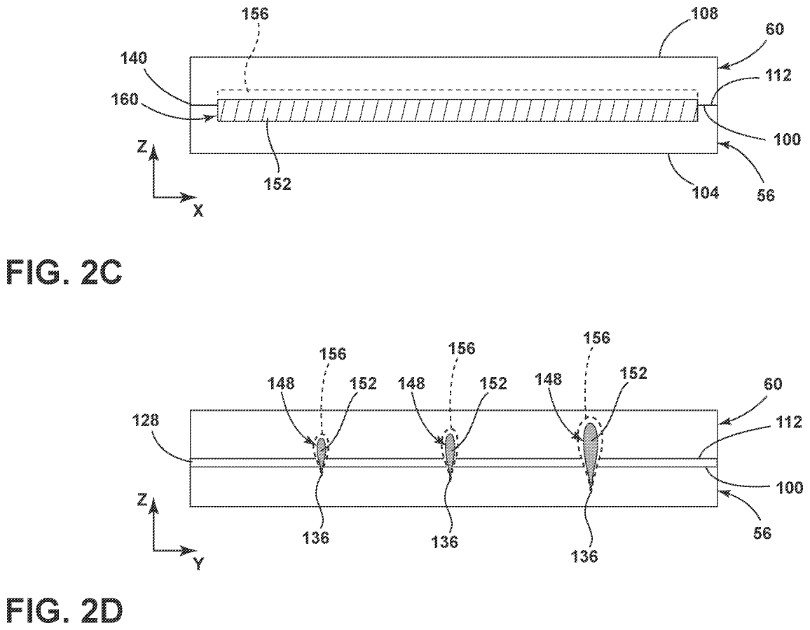

Referring now to FIGS. 2A-2D, a method of joining substrates to one another, such as the first and second glass substrates 56, 60, which was performed experimentally, is illustrated. In this experiment, lack of optical contact between the first and second glass substrates 56, 60 was established by etching a series of channels 96 in a first top surface 100 of the first glass substrate 56. The first top surface 100 is opposite to a first bottom surface 104 of the first glass substrate 56. The second glass substrate 60 includes a second top surface 108 and a second bottom surface 112. Optical contact between the first top surface 100 and the second bottom surface 112 occurred in regions that were between the channels 96. However, optical contact was not specifically sought in the experiments. To demonstrate the capabilities of the method of joining substrates to one another, the channels 96 were etched with a depth 116 and a width 120. The depth 116 of the channels 96 in one specific example was about 1.8 μm, the width 120 of the channels 96 was about 2.0 mm, and a thickness 124 of the first glass substrate 56 was about 0.7 mm. However, the dimensions of the depth 116 and/or the width 120 of the channels 96 were altered in various experiments to demonstrate the capabilities of the method of joining glass substrates to one another, as will be discussed in further detail herein.

Referring again to FIGS. 2A-2D, once the second glass substrate 60 is placed upon the first glass substrate 56 having the etched channels 96, the channels 96 may be referred to as a gap 128 that is defined by the first and second glass substrates 56, 60. Similarly, the depth 116 of the channels 96 may be referred to as a height 132 of the gaps 128. In general, the depth 116 and the height 132 may substantially correspond with one another. However, it is contemplated that, in some examples, the height 132 may be slightly greater than the depth 116 due to imperfections and/or inconsistencies in the contact between the first top surface 100 and the second bottom surface 112. To join the first and second glass substrates 56, 60 to one another, the light 28 from the light source 24 is focused onto the first glass substrate 56 by the focusing lens 52. More specifically, the focusing lens 52 focuses the light 28 to a focal point 136 that is within the first glass substrate 56 and between about 40 μm and about 90 μm away from an interface 140 between the first and second glass substrates 56, 60. Then, the translational stage 88 is employed to adjust a position of the first and second glass substrates 56, 60 relative to the light 28 such that the light 28 and the focal point 136 traverse the first and second glass substrates 56, 60 along at least one axis, as indicated by arrow 144. The focusing of the light 28 within the first glass substrate 56 results in an increase in temperature of a localized volume 148 of the first glass substrate 56 and the second glass substrate 60. However, the first and second glass substrates 56, 60 each exhibit a transmittance at a wavelength of the light 28 that is at least about 90%. Accordingly, the induced increase in temperature of the localized volume 148 of the first glass substrate 56 and the second glass substrate 60 is not substantially attributable to absorption at the wavelength of the light 28. Rather, energy from the light 28 is absorbed nonlinearly by multiphoton ionization followed by avalanche ionization. The localized volume 148 includes at least one area chosen from a plasma region 152 and a heat-affected zone 156. Said another way, the localized volume includes the plasma region 152 and/or the heat-affected zone 156. In some examples, such as those that employed fused silica, the fused silica did not show signs of the heat-affected zone 156 having been generated within the localized volume 148. The localized volume 148 extends away from the focal point 136 in a generally tear-dropped shape, with the plasma region 152 occupying an interior of the localized volume 148 and the heat-affected zone 156, when present, occupying an exterior of the localized volume 148. As the number of pulses from the light source 24 increases, the localized volume 148 expands toward the focusing lens 52, thereby giving the localized volume 148, the plasma region 152, and the heat-affected zone 156 the tear-dropped shape. The plasma region 152 and the heat-affected zone 156 are present in both the first glass substrate 56 and the second glass substrate 60.

Referring further to FIGS. 2A-2D, the induced temperature increase in the localized volume 148 by the focusing of the light 28 to the focal point 136 results in a melting of the first and second glass substrates 56, 60. Accordingly, as the translational stage 88 adjusts the position of the first and second glass substrates 56, 60 relative to the light 28, a weld line 160 can be established or defined. The weld line 160 similarly includes the plasma region 152 and the heat-affected zone 156. As the translational stage 88 moves, melted regions of the first and second glass substrates 56, 60 that are remote from the focal point 136 of the light 28 begin to cool and solidify. In areas that included the gaps 128, the melted first glass substrate 56 and/or the melted second glass substrate 60 fill or otherwise close the gap 128. Accordingly, as the melted first glass substrate 56 and/or the melted second glass substrate 60 solidify, the first and second glass substrates 56, 60 become joined together and the interface 140 becomes less perceptible. The joined first and second glass substrates 56, 60 can be referred to as an article. As illustrated in FIG. 2D, a duration of exposure to the light 28 at a given location and/or a position of the focal point 136 within the first glass substrate 56 can impact a size of the localized volume 148 and a distribution of the localized volume 148 between the first and second glass substrates 56, 60.

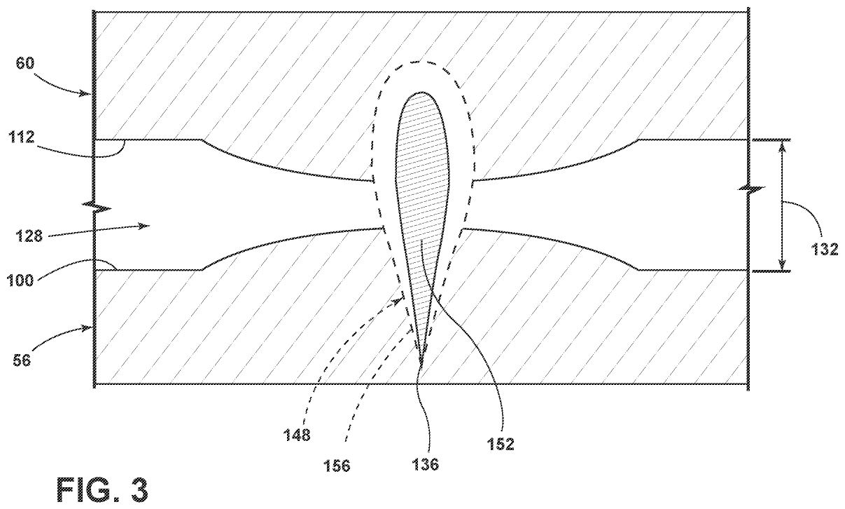

Referring now to FIG. 3, the focal point 136 of the light 28 is shown within the first glass substrate 56. The localized volume 148 that has an increased temperature extends from the first glass substrate 56, across the gap 128, and into the second glass substrate 60. The plasma region 152 and the heat-affected zone 156 are present in the first glass substrate 56, the second glass substrate 60, and the gap 128. Accordingly, the first top surface 100 and the second bottom surface 112 deform and begin to fill the gap 128 as the first and second glass substrates 56, 60 melt as a result of the increased temperature within the localized volume 148. In various examples, the height 132 of the gap 128 that is closed or filled can be up to about 10 μm. For example, the height 132 of the gap 128 that is filled or closed can be between about 1 μm to about 10 μm. Accordingly, the height 132 of the gap 128 can be about 0 μm, less than about 1 μm, about 1 μm, about 2 μm, about 3 μm, about 4 μm, about 5 μm, about 6 μm, about 7 μm, about 8 μm, about 9 μm, about 10 μm, and/or combinations or ranges thereof. The aforementioned heights 132 of the gap 128 can correspond to a natural gap that occurs between the first and second glass substrates 56, 60 when the first and second glass substrates 56, 60 are brought into contact with one another. That is, the methods of joining substrates to one another discussed herein are capable of executing such joining without requiring the establishment of optical contact between the first glass substrate 56 and the second glass substrate 60. The term “natural gap,” as used herein, is intended to refer to the spacing between two surfaces when they have been brought into contact with one another without performing the polishing and/or cleaning steps necessary to establish optical contact between the surfaces. Therefore, the methods of joining glass substrates to one another disclosed herein are capable of joining glass substrates to one another in a manner that decreases processing steps and increases throughput. Additionally, as will be discussed further herein, the methods of joining substrates to one another can be employed for joining substrates that are mismatched in their coefficients of thermal expansion (CTE). For example, the methods of joining substrates to one another disclosed herein have been employed to join glass substrates together that had a CTE mismatch, or difference, of up to about 9 ppm/° C.

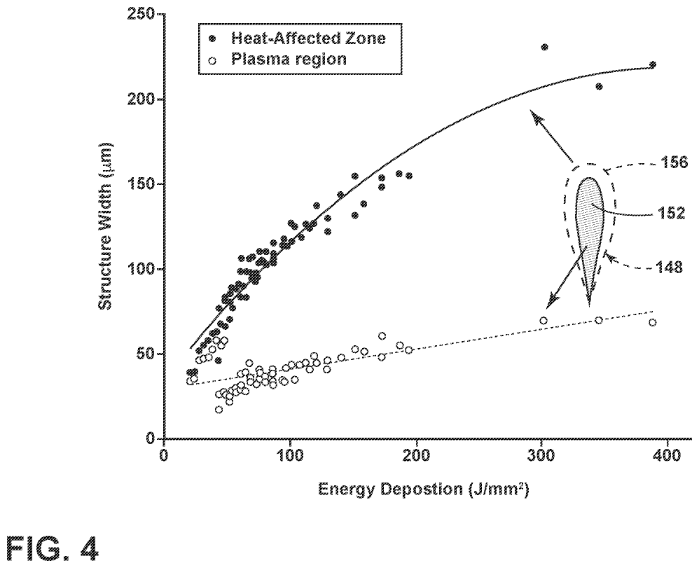

Referring to FIG. 4, a width, in micrometers, of the plasma region 152 and the heat-affected zone 156 as a function of energy deposition, in J/mm², from the light 28 emitted by the light source 24 is depicted. The energy deposition was calculated from pulse energy, translation speed, pulse repetition rate, and beam diameter using Equation 1, below. The energy deposition calculated with Equation 1 was utilized to quantify and characterize the combined effect of varying the pulse energy, the translation speed, and the pulse repetition rate. The beam diameter remained constant for the experimental results depicted in FIG. 4. As can be seen in FIG. 4, as energy deposition by the light 28 from the light source 24 increases, the structure width of the plasma region 152 and the structure width of the heat-affected zone 156 both increased. The structure widths of the plasma region 152 and the heat-affected zone 156 were taken at the widest point in the tear-drop shape of the localized volume 148.

$$Energy Deposition = \frac{Pulse Energy}{\begin{matrix}Translation Speed ⨯ Repitition Rate ⨯ \\ Beam Diameter\end{matrix}} \qquad ( 1 )$$

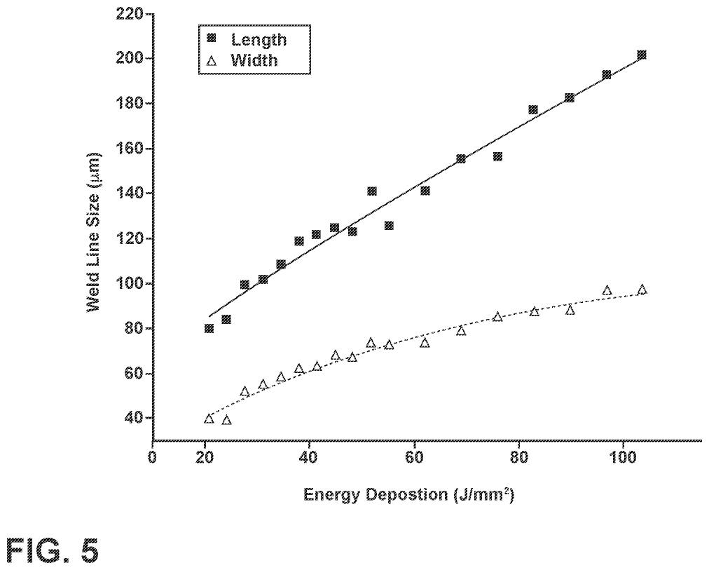

Referring now to FIG. 5, a width and a length of the weld line 160 are plotted as a function of the energy deposited by the light 28 from the light source 24. The length of the weld line 160 primarily depended upon the extent of translation by the translational stage 88. However, the width of the weld line 160 depended on the energy deposited by the light 28 from the light source 24 and the resulting dimensions of the plasma region 152 and the heat-affected zone 156. As can be seen in FIG. 5, as the deposited energy increases, the width of the weld line 160 also increases.

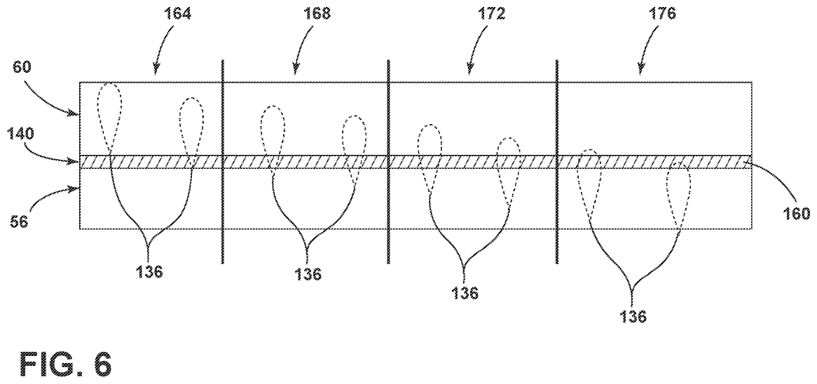

Referring to FIG. 6, positioning of the focal point 136 relative to the interface 140 between the first glass substrate 56 and the second glass substrate 60 is illustrated. The focal point 136 was moved from the interface 140 at the left extreme in FIG. 6 to about 95 μm away from the interface 140 and within the first glass substrate 56 at the right extreme in FIG. 6 to evaluate the effect of focal point 136 position on the quality of the weld line 160. More specifically, the focal point 136 was moved from the interface 140 to about 95 μm within the first glass substrate 56 in a step-wise and sequential manner. Weld lines 160 were established between the interface 140 and about 95 μm within the first glass substrate 56 at about 5 μm increments. It was found that the weld lines 160 established within a first zone 164 that extended from the interface 140 to about 10 μm within the first glass substrate 56 exhibited a defect in the second glass substrate 60 and failed to establish an adequate joining between the first and second glass substrates 56, 60. Additionally, it was found that the weld lines 160 established within a second zone 168 that extended between about 15 μm and about 45 μm away from the interface 140 and within the first glass substrate 56 exhibited a defect in the first glass substrate 56. Further, it was found that the weld lines 160 established within a third zone 172 that extended between about 50 μm and about 80 μm away from the interface 140 and within the first glass substrate 56 exhibited a joining of the first and second glass substrates 56, 60 that was satisfactory and free of defects. Finally, it was found that the weld lines 160 established within a fourth zone 176 that extended between about 85 μm and about 95 μm away from the interface 140 and within the first glass substrate 56 exhibited a defect in the second glass substrate 60. Accordingly, the third zone 172 represents a tolerance window that was observed for the positioning of the focal point 136 between about 50 μm and about 80 μm away from the interface 140 and within the first glass substrate 56.

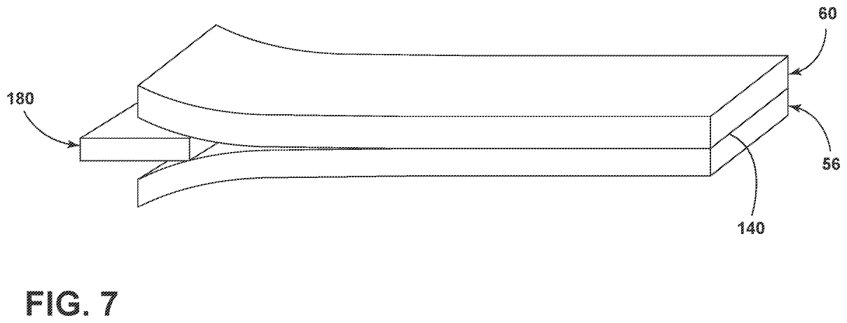

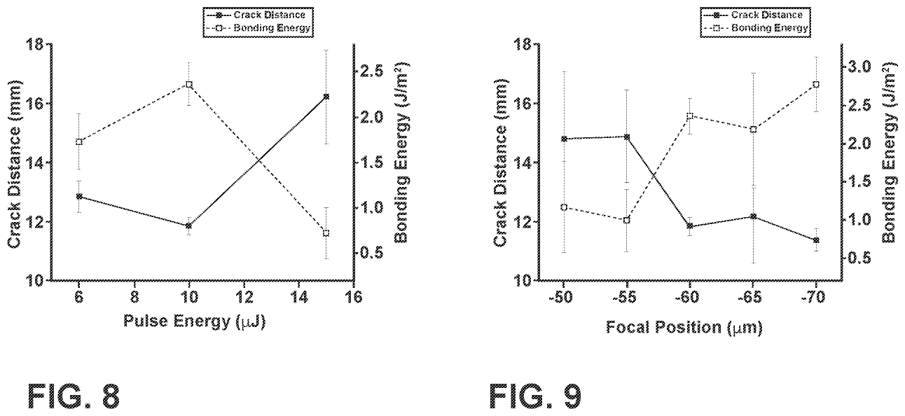

Referring now to FIGS. 7-9, a crack opening test was performed to evaluate a bonding energy of the joining between the first glass substrate 56 and the second glass substrate 60. The bonding energy is given by Equation 2. In Equation 2, t_{knife} is the knife thickness, d is the glass thickness, l is the crack length, and E is Young's modulus. For the crack opening test, the joined first and second glass substrates 56, 60 were secured to a support structure (e.g., a vacuum chuck) and a knife 180 was inserted at the interface 140 between the first and second glass substrates 56, 60. The knife 180 was coupled to a digital micrometer that advanced the knife 180 at a given translation velocity. The translation velocity was set to 100 mm/s. FIG. 8 illustrates the measured crack distance, in millimeters, and the calculated bonding energy, in J/m², as a function of pulse energy, in μJ. FIG. 9 illustrates the measured crack distance, in millimeters, and the calculated bonding energy, in J/m², as a function of focal position, in μm. The focal position, or location of the focal point 136, enumerated in FIG. 9 used the interface 140 as a zero point and assigned negative values to positions within the first glass substrate 56 as the first glass substrate 56 was below the second glass substrate 60 in these experiments. For example, the data points associated with the focal position of −60 μm represent the focal point 136 being positioned within the first glass substrate 56 and 60 μm away from the interface 140. The bonding energies calculated from the crack opening test were in the range of 0.73 J/mm² to 2.77 J/mm². A maximum bonding energy of 2.77±0.35 J/mm² was achieved when the light 28 was focused at 70 μm away from the interface 140 and within the first glass substrate 56 while the pulse energy of the light source 24 was 10 μJ. In joining the first and second glass substrates 56, 60 to one another for evaluation, individual weld lines 160 were established with adjacent weld lines 160 being separated by 2 mm.

$$γ = \frac{3 {t}_{knife}^{2} {d}^{3} E}{32 {l}^{4}} \qquad ( 2 )$$

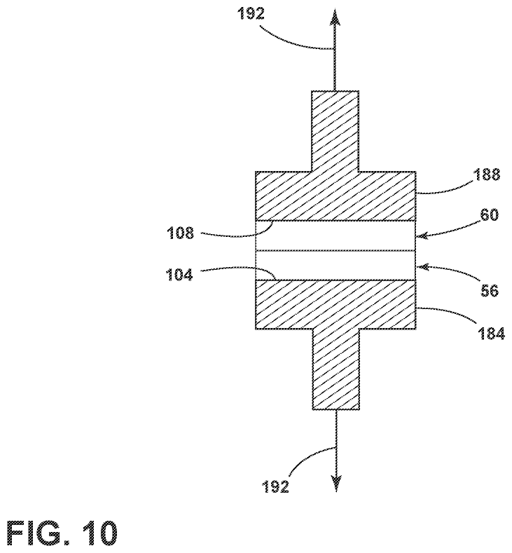

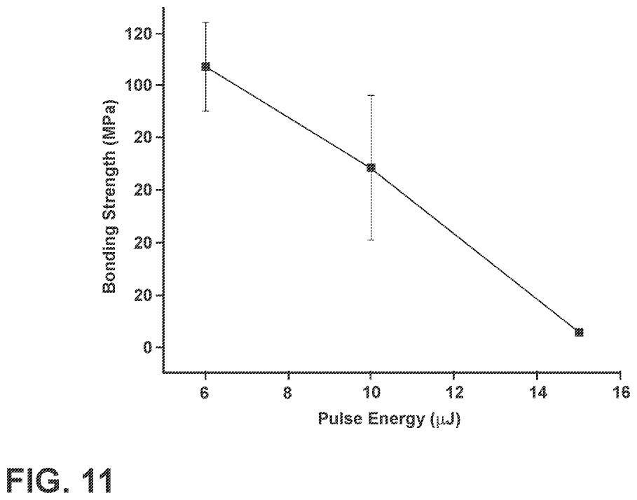

Referring to FIGS. 10-11, the bonding strength of the joining between the first and second glass substrates 56, 60 was evaluated using a tensile strength test. The bonding strength is obtained by subtracting an averaged value of break forces exhibited by optically contacted first and second glass substrates 56, 60 from a maximum breaking force for the joined or welded first and second glass substrates 56, 60, followed by a normalization over the joined or welded area. The joined or welded area for these evaluations was a 10 mm² area that was joined or welded by close-loop welding. The bonding strength is calculated with Equation 3, where F_{w} is the maximum sample breaking force, σ_{OC} is the breaking strength exhibited by optical contact, A_{OC} is the optical contact area, and A_{welding} is the total welding area. In testing the bonding strength, the first bottom surface 104 of the first glass substrate 56 was adhered to a first fixture 184 and the second top surface 108 of the second glass substrate 60 was adhered to a second fixture 188. A tensile force was applied to the first and second fixtures 184, 188, as indicated by arrows 192, by increasing a distance between the first and second fixtures 184, 188 at a rate of 0.05 mm/s. FIG. 11 depicts the bonding strength as a function of pulse energy. As can be seen in FIG. 11, as the pulse energy increased, the bonding strength of the joining between the first and second glass substrates 56, 60 decreased.

Referring again to FIGS. 10-11, the optical contact force was calculated to be about 204±78 kPa. The area of optical contact for each sample was measured using interference fringes that were visible by optical imaging. A maximum bonding strength of 107±17 MPa was observed for a pulse energy of 6 μJ. Before executing the tensile strength test, a phase retardance image was collected from a top view of the joined first and second glass substrates 56, 60. The phase retardance image demonstrated an internal stress level for the joined glass substrates. While the phase retardance images are not shown, as the pulse energy from the light source 24 increased, a non-uniform retardance was observed in the weld lines 160 and the surrounding area. The non-uniform retardance was indicative of residual stress within the joined first and second glass substrates 56, 60. Residual stress can limit the bonding strength.

Referring particularly to FIGS. 1-11, the light source 24 used was an 800 kHz Trumpf Micro 5050C laser with a pulse duration of 10 picoseconds at a wavelength of 1030 nm. The focal length of the focusing lens 52 was 30 mm, which resulted in a diameter of the focal point 136 that was about 2.3 μm. The vacuum chuck 64 that held the first and second glass substrates 56, 60 was fixed on a two-axis tilt platform 68 that included the first portion 72, the second portion 76, the first adjustable member 80, and the second adjustable member 84. The tilt platform 68 aided in avoiding any horizontal or vertical tilting of the first and second glass substrates 56, 60 during the joining process, thereby maintaining a desired angle of the first and second surfaces 56, 60 relative to the light 28. In the experiments for the above substrate joining system 20, it was observed that, as pulse energy increased or translation speed decreased, the internal stress accumulated within the first and second glass substrates 56, 60 increased. This increase in accumulated internal stress lead to an increased incidence of crack formation along the weld lines 160. It was also observed that the focusing depth, or position of the focal point 136, affected the shape of the molten volume contained within the localized volume 148.

As discussed above with regard to FIG. 6, depending on the position of the focal point 136 relative to the interface 140, the modification induced by the welding or joining process can be elongated and lead to aberrations or defects. Accordingly, the deposited energy calculated with Equation 1 was used to quantify the combined effect of the various welding parameters. As the energy deposited increased, the size of the weld line 160 also increased. Conditions were identified that provided a crack-free joining between the first and second glass substrates 56, 60 when the deposited energy was in the range of about 20 J/mm² to about 390 J/mm², with the width of the weld line 160 being in the range of about 40 μm to about 230 μm. The first and second glass substrates 56, 60 in the above experiments were made of the same material. The first and second glass substrates 56, 60 were each an alkaline earth boro-aluminosilicate glass (marketed as EAGLE XG® by Corning Incorporated) and each having a thickness of about 0.7 mm.

The above substrate joining system 20 and method demonstrated a new and flexible vacuum assisted ultrafast laser welding system that includes an ultrafast pulsed laser as the light source 24, an integrated set of beam transport and focusing optics, a controlled X-Y-Z translational stage 88, and a vacuum clamping system in the form of the vacuum chuck 64. Compared with conventional ultrafast laser welding techniques, the above substrate joining system 20 provides an improved system that allows for a standardization of the pressure needed to weld or join two glass substrates (e.g., the first and second glass substrates 56, 60). Accordingly, the present disclosure represents a non-contact system that is less dependent on a flatness and a cleanness of the first and second glass substrates 56, 60. The ultrafast laser welding by a picosecond pulsed laser and the optimization of processing parameters was performed on the alkaline earth boro-aluminosilicate glass (marketed as EAGLE XG® by Corning Incorporated) mentioned above. This alkaline earth boro-aluminosilicate glass is commonly used in modern display devices. It was found that there exists a crack-free welding condition range in scanning speed and laser output irradiance at a given laser pulse repetition rate. The deposited laser energies for crack-free welding conditions ranged from 20 J/mm² to 388 J/mm².

In another regard, the ability to weld glass without the need to establish optical contacting was demonstrated. The above substrate joining system 20 demonstrated that glass samples can be bonded with a lower surface quality, which leads to reduced costs. Specifically, it was demonstrated that a gap of at least about 2 μm could be closed and thereby seal the interface 140 between the first and second glass substrates 56, 60 without cracks or defects. The welding speeds were up to 100 mm/s and the deposited laser energies were preferably in the range of 20 J/mm² to 104 J/mm². A 30 μm focal point 136 position tolerance window (third zone 172) was observed in this welding condition. The bonding energy and bonding strength of the joined glass substrates were measured up to 2.77±0.35 J/mm² and 107±17 MPa, respectively.

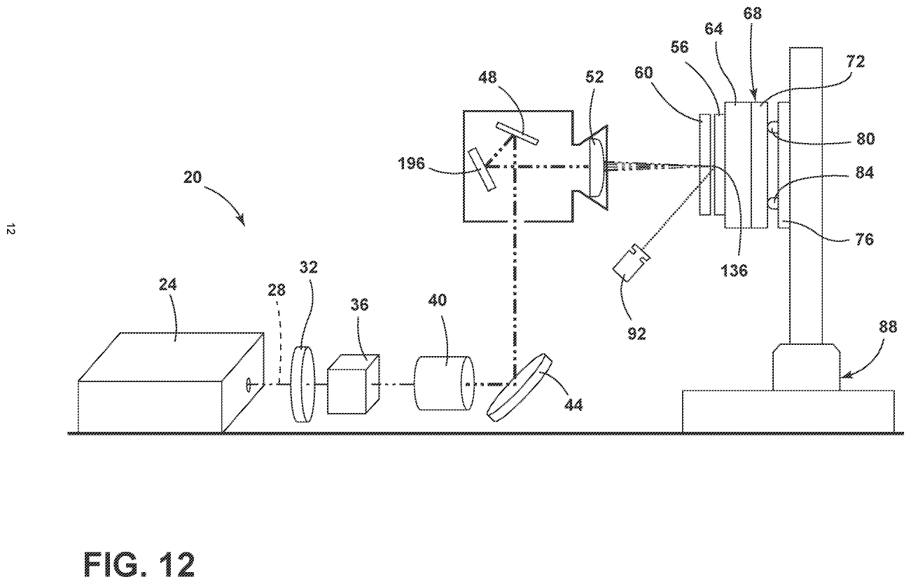

Referring now to FIG. 12, the substrate joining system 20 depicted in FIG. 1 is altered to include a galvo scan head 196 that is positioned between the second mirror 48 and the focusing lens 52. More specifically, the second mirror 48, the galvo scan head 196, and the focusing lens 52 are housed within a galvo scanner 200. The focusing lens 52 in the depicted example is an F-theta lens. The substrate joining system 20 depicted in FIG. 1 is capable of adjusting the position of the first and second glass substrates 56, 60 relative to the light 28 from the light source 24. The substrate joining system 20 depicted in FIG. 12 is capable of adjusting the position of the first and second glass substrates 56, 60 relative to the light 28 from the light source 24 and is additionally capable of adjusting the position of the light 28 relative to the first and second glass substrates 56, 60 with the addition of the galvo scanner 200. For example, the translational stage 88 can adjust a position of the first and second glass substrates 56, 60 relative to the light 28 along a first axis and the galvo scanner 200 can adjust a position of the light 28 relative to the first and second glass substrates 56, 60 along a second axis. The first and second axes are angularly offset from one another. For example, the first axis and the second axis can be angularly offset from one another by up to about ninety degrees (90°). For example, the angular offset can be about ninety degrees (90°), about eighty degrees (80°), about seventy degrees (70°), about sixty degrees (60°), about fifty degrees (50°), about forty degrees (40°), about thirty degrees (30°), about twenty degrees (20°), about ten degrees (10°), about zero degrees (0°), and/or combinations or ranges thereof. The movement of the light 28 relative to the first and second glass substrates 56, 60 provided by the galvo scanner 200 can be referred to as rastering. The velocity of movement that is provided by the translational stage 88, which can be referred to as a feed velocity, v_{f}, can be up to about 100 mm/s. The velocity of movement of the light 28 that is provided by the galvo scanner 200, which can be referred to as a scan velocity, vₛ, can be up to about 2 m/s. It is worth noting that glass substrate joining processes that are similar to the above-described low-speed welding process often limit the translation speed during welding to less than 100 mm/s in an effort to provide ample time to achieve a heat accumulation effect within the glass substrates being joined. This heat accumulation effect is relied upon in such glass substrate joining processes to join the glass substrates to one another. However, the on-the-fly welding process is not limited to the speed of the translational stage 88 for establishing the weld lines 160 over a treatment area. Accordingly, the use of the galvo scanner 200 can provide an increased throughput to the substrate joining system 20.

Referring again to FIG. 12, the substrate joining system 20 includes the light source 24 that emits the light 28. In one specific example, the light source 24 is a picosecond pulsed laser. The light 28 emitted from the light source 24 passes through the half-wave plate 32, the beam splitter 36, and the beam expander 40 on its way to the first mirror 44. The beam expander 40 expanded the diameter of the light 28 from the light source 24 to a diameter of 14 mm. The light 28 emitted from the light source 24 is directed to the second mirror 48, which is within the galvo scanner 200, by the first mirror 44. While the galvo scanner 200 is depicted, the present disclosure is not limited to use of the galvo scanner 200 in enabling the rastering of the light 28. For example, a polygon scanner or other suitable device may be utilized. From the second mirror 48, the light 28 is directed to the galvo scan head 196 within the galvo scanner 200. The galvo scanner 200 was used to transform directivity of the light 28 in different dimensions by the deflection provided by the second mirror 48 and the galvo scan head 196. The galvo scan head 196 directs the light 28 to the focusing lens 52. In one specific example, the focusing lens 52 is an F-theta lens that has a focal length of 45 mm and produces the focal point 136 with a diameter of about 4.22 μm. The focusing lens 52 is employed to focus the light 28 from the light source 24 onto the first glass substrate 56 and/or the second glass substrate 60. The first glass substrate 56 is positioned on the vacuum chuck 64. The vacuum chuck 64 is supported by the tilt platform 68. The tilt platform 68 can be employed to adjust an angular relationship between light 28 and the first glass substrate 56 and/or the second glass substrate 60. The tilt platform 68 can include the first portion 72 and the second portion 76. The first portion 72 can be coupled to the second portion 76 by the first adjustable member 80 and the second adjustable member 84. In various examples, a distance between the first portion 72 and the second portion 76 can be changed by adjusting the first adjustable member 80 and/or the second adjustable member 84. For example, the first and second adjustable members 80, 84 may be threaded fasteners that can be rotated to adjust an angular orientation of the first portion 72, which in turn can adjust an angular orientation of the vacuum chuck 64, the first glass substrate 56, and/or the second glass substrate 60 relative to the light 28. The tilt platform 68 is coupled to the translational stage 88. The translational stage 88 can be an X-Y-Z linear translational stage. The camera 92 is utilized to observe the light 28, the first glass substrate 56, and/or the second glass substrate 60 when positioning the focal point 136 of the light 28 coming from the focusing lens 52. The light source 24 employed in the substrate joining system 20 depicted in FIG. 12 was an 800 kHz Trumpf Micro 5050C laser with a pulse duration of 10 picoseconds at 1030 nm.

With regard to the substrate joining system 20 depicted in FIG. 12, a method was developed to control a thermal profile and a thermal history in the first and second glass substrates 56, 60 as a result of an ultrafast glass substrate joining process. In this process, strong bonding of glass materials with high coefficients of thermal expansion (CTE), as well as glass materials with large differences in their coefficients of thermal expansion (CTE) were successfully joined. For industrial applications, the joining of materials with large differences in their CTEs and melting point is often necessary in fulfilling a wider range of application areas. Typically, defect formation is most prominent for high CTE and CTE mismatched glasses when optical contact is not employed. These defects are often due to the thermal expansion and contraction of the glass material that lead to larger residual stress within the joined materials, as well as cracks after execution of the joining process. In order to be able to join the high CTE or CTE mismatched glasses, the crack formation tendency must be suppressed. In the welding or joining process, the temperature distribution by laser irradiation is important because it can affect the main factors of modification such as glass melting and resolidification, as well as the residual stress. Therefore, the ultrafast laser welding techniques discussed herein were developed to control a thermal history of the first and second glass substrates 56, 60 during the joining process. In controlling the thermal history, it was important to control the temperature gradient during the joining process. Accordingly, the process described herein provides a unique and slow-cooling temperature dynamic (see FIG. 16), which allows for a reduction in residual stress and an enhanced bonding strength while enabling high throughput for the process.

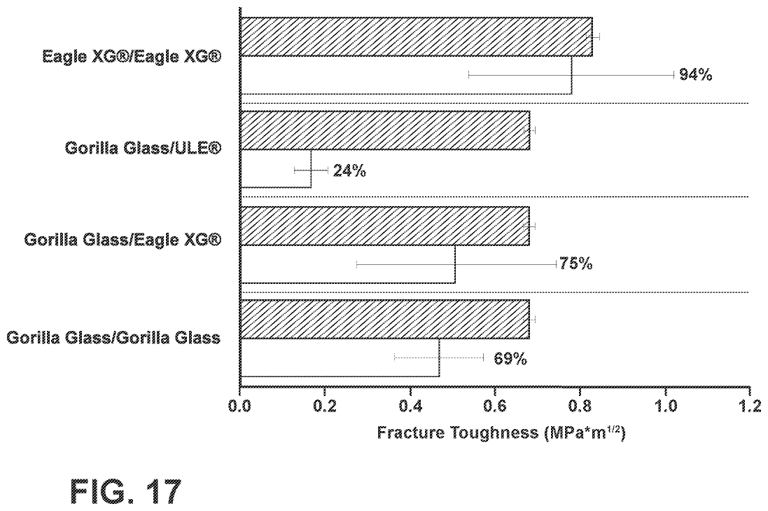

As will be discussed further herein, the methods also include the usage of an on-the-fly rapid scanning strategy, where the galvo scanner 200 follows a bidirectional raster pattern while the translational stage 88 moves continuously or in a stepwise manner. Advantages of the on-the-fly process include, but are not limited to, wide material selection with CTE mismatches up to about 9 ppm/° C., reduced stress, reduced crack generation, long-term stable connections with extremely high fracture toughness that can be up to the fracture toughness of the original material (see FIG. 17), low energy dosing requirements, high welding throughput, and a flexibly designed welding process.

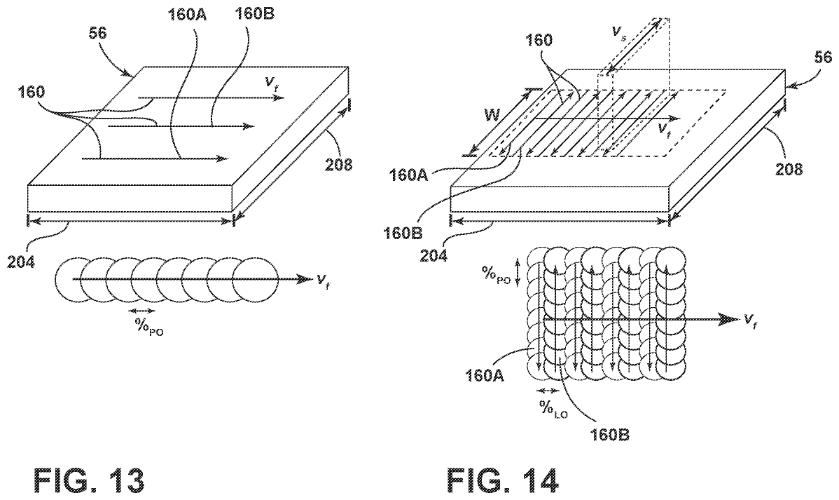

Referring to FIG. 13, the first glass substrate 56 is depicted without the second glass substrate 60 positioned thereupon to simplify the illustration and description of the joining process. As the second glass substrate 60 is coupled to the first glass substrate 56 during the joining process, movements that are discussed with regard to the first glass substrate 56 similarly apply to the second glass substrate 60. Additionally, while the first glass substrate 56 is discussed as moving, one of skill in the art will recognize that such movements are effected by the translational stage 88. The process depicted in FIG. 13 corresponds to the substrate joining system 20 depicted in FIG. 1. The translational stage 88 moved the first glass substrate 56 continuously at a feed velocity, v_{f}, of about 100 mm/s. The light source 24 utilized was a picosecond laser. Accordingly, as the position of the first glass substrate 56 relative to the light 28 was adjusted by the feed velocity, a pulse overlap between sequential pulses from the light source 24 occurred. The overlap between temporally sequential pulses from the light source 24 can be expressed as a pulse overlap percentage (%_{PO}). The pulse overlap for these experiments was 94.60%, as indicated in Table 1. As the first glass substrate 56 was translated and the light source 24 was emitting the light 28, the weld line 160 was established.

As illustrated in FIG. 13, the first glass substrate 56 was moved along a first axis 204 that corresponded with a direction of propagation of the weld lines 160. Once a first weld line 160A was established, the first glass substrate 56 was translated along a second axis 208 with the light source 24 in a state that does not emit the light 28 (e.g., off or not energized) and also returned to a position that is proximate to a starting point of the first weld line 160A. The light source 24 was then placed back into a state that emits the light 28 (e.g., on or energized) and a second weld line 160B was initiated. Accordingly, unidirectional discrete weld lines 160 were established. However, the present disclosure is not so limited. Rather, sequential discrete weld lines 160 can be established with the sequential discrete weld lines 160 being established in opposing directions. For example, the first weld line 160A can be established in a positive direction along the first axis 204 and the second weld line 160B can be established in a negative direction along the first axis 204. The process depicted and described in FIG. 13 may be referred to as a low-speed welding process.

Referring now to FIG. 14, the first glass substrate 56 is depicted without the second glass substrate 60 positioned thereupon to simplify the illustration and description of the joining process. As the second glass substrate 60 is coupled to the first glass substrate 56 during the joining process, movements that are discussed with regard to the first glass substrate 56 similarly apply to the second glass substrate 60. Additionally, while the first glass substrate 56 is discussed as moving, one of skill in the art will recognize that such movements are effected by the translational stage 88. The process depicted in FIG. 14 corresponds to the substrate joining system 20 depicted in FIG. 12. The light source 24 utilized was a picosecond laser. Rather than adjusting the position of the first glass substrate 56 relative to the light 28 while the light 28 was emitted from the light source 24 to establish the weld lines 160, the position of the light 28 relative to the first glass substrate 56 was adjusted by the galvo scan head 196 of the galvo scanner 200. Accordingly, as the position of light 28 relative to the first glass substrate 56 was adjusted, a pulse overlap between sequential pulses from the light source 24 occurred. The overlap between temporally sequential pulses from the light source 24 can be expressed as a pulse overlap percentage (%_{PO}). The pulse overlap for these experiments was 40.72%, as indicated in Table 1. As the light 28 traversed the first glass substrate 56, the weld line 160 was established. In these experiments, the weld lines 160 were established along the second axis 208. Once the first weld line 160A was established, the translational stage 88 moved the first glass substrate 56 at a feed velocity, v_{f}, of between about 2 mm/s and about 10 mm/s. While the translational stage 88 moved the first glass substrate 56 along the first axis 204, the light source 24 remained on or energized such that the light 28 was emitted and a continuous treatment area was established. Movement of the translational stage 88 can be done continuously while the weld line 160 is being established (i.e., in a simultaneous manner) or in a step-wise fashion after the weld line 160 was established (i.e., in a sequential manner).

Referring again to FIG. 14, the above-articulated process for establishing the first weld line 160A was repeated to establish the second weld line 160B. The second weld line 160B overlapped with the first weld line 160A, as will be discussed further herein. However, the first and second weld lines 160A, 160B were established in opposing directions. That is, the first weld line 160A was established in a negative direction of the second axis 208 and the second weld line 160B was established in a positive direction of the second axis 208. While positive and negative directions of the first and second axes 204, 208 are discussed relative to the establishment of the weld lines 160, such discussion should not be interpreted as establishing a difference or preference for a directionality in establishing the weld lines 160. Rather, the positive and negative directions of the first and second axes 204, 208 are referred to in an effort to describe the process in a clear and concise manner. In the process depicted in FIG. 14, adjacent weld lines 160 were established in opposing directions of the second axis 208 such that a pattern of weld line 160 establishment was generally serpentine. Additionally, when the first glass substrate 56 was moved by the translational stage 88 to establish a subsequent one of the weld lines 160, the first glass substrate 56 was adjusted in position relative to the light 28 such that the subsequent one of the weld lines 160 overlapped with the immediately previous weld line 160. The overlap between subsequent or sequential weld lines 160 can be referred to as a line overlap. A degree of overlap between the weld lines 160 can be expressed as a line overlap percentage (%_{LO}). The line overlap percentages in the process depicted in FIG. 14 were up to about 99%. For example, the line overlap can be zero percent such that sequential pulses do not overlap. Alternatively, the pulse overlap can be up to about 10%, up to about 20%, up to about 30%, up to about 40%, up to about 50%, up to about 60%, up to about 70%, up to about 80%, up to about 90%, up to about 99%, and/or combinations or ranges thereof. The process depicted and described in FIG. 14 may be referred to as an on-the-fly welding process.

Table 1, below, summarizes a variety of process conditions used in the low-speed welding process and the on-the-fly welding process for comparison purposes. Of particular note is the significant decrease in the energy dose delivered by the on-the-fly welding process when compared to the low-speed welding process while increasing throughput of the welding process.

A numerical solution for thermal conduction was developed for modeling purposes. The numerical solution for thermal conduction simulated temperature distribution in a moving bulk glass when subjected to the on-the-fly welding process. The simulations were not intended to be predictive, nor to fully describe the welding process, but rather to identify the main tendencies of thermal conduction for the on-the-fly welding process. The thermal conduction model for glass welding by ultrashort pulses from the light source 24 (e.g., laser) was developed where an instantaneous heat source moves in both the x direction and the y direction to model the raster scan used in the on-the-fly welding experiments. In the simulation, it was assumed that the light 28 propagates along the z direction in the glass substrate with a Gaussian shape. A variety of the parameters used in the simulation were derived from experimental values that can be found in Table 1. The heat diffusion equation, listed as Equation 3, below, was the governing fundamental equation to calculate the temperature distribution in the simulation.

TABLE 1
Low-Speed and On-The-Fly Welding Process Conditions

| Parameter | Symbol | Unit | Low-Speed | On-The-Fly |
|---|---|---|---|---|
| Wavelength | λ | μm | 1.03 | 1.03 |
| Beam Diameter | wᵢ | mm | 17.00 | 14.00 |
| Focal Length | F | mm | 30.00 | 45.00 |
| Numerical Aperture | NA | — | 0.27 | 0.15 |
| Focal Point Diameter | 2w₀ | μm | 2.32 | 4.22 |
| Depth of Focus | DOF | μm | 8.17 | 27.11 |
| Average Power | P | W | 8.00 | 4.00 |
| Frequency | F | kHz | 800.00 | 800.00 |
| Pulse Energy | E | μJ | 10.00 | 5.00 |
| Feed Velocity | ν_{f} | mm/s | 100.00 | 2.00 |
| Scanning Velocity | νₛ | mm/s | — | 2000.00 |
| Weld Width | w | μm | 2.32 | 500.00 |
| Pulse Overlap | %_{PO} | % | 94.60 | 40.72 |
| Weld Line Overlap | %_{LO} | % | 0 | 88.14 |
| Pulses in 1 mm² | N | — | 1.96 × 10⁶ | 8.00 × 10⁵ |
| Energy Dose | E_{d} | J/mm² | 19.58 | 4.00 |

$$\frac{dT}{\partial t} = D {\overline{V}}^{2} T \qquad ( 3 )$$

In Equation 3, above, the thermal diffusivity is given by Equation 4, below.

$$D = \frac{k}{ρ {C}_{P}} \qquad ( 4 )$$

Equation 4 is solved via Fourier transform, involving the thermal conductivity, k, the material density, ρ, and the specific heat capacity at constant pressure, Cp. The energy from the light source 24 is absorbed nonlinearly by photoionization followed by avalanche ionization. For the purposes of the simulation, it was assumed that energy deposition was instantaneous with an absorption rate of 0.5. To simulate a pulse from the light source 24, an instantaneous change in temperature from the energy deposited by the light source 24 was calculate and then added to the function T for each pulse. The temperature profile did not show a strict dependency on the nonlinear absorptivity of the ultrashort pulses from the light source 24.

To reduce calculation time, the simulation area was narrowed down to an area of 100 μm×100 μm, while maintaining the width of the treated range at 0.5 mm and the length of the treated range at 40 mm. In the simulation, the scan speed of the laser beam in the x direction was set to 2 m/s, which corresponded to movement of the galvo scan head 196, and 5 mm/s for stage translation in the y direction. These settings were chosen to match practical settings that were employed in the experiments. In the z direction, the modification length was chosen according to the Raleigh length of the focused beam from the light source 24. The simulation revealed a thermal accumulation effect and uniform temperature increase over the entire welding area. The temperature locally increased at each location where the light 28 interacted with the glass substrate and the temperature exceeded the melting temperature of the glass substrate, which lead to larger interaction volumes and a larger molten area.

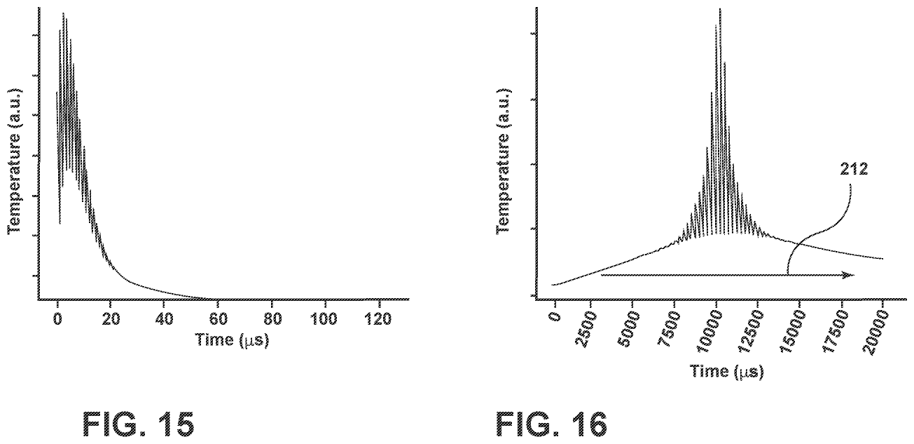

Referring to FIGS. 15 and 16, a temporal temperature evolution is depicted for the low-speed welding process (FIG. 15) and the on-the-fly welding process (FIG. 16) at a fixed center point within the treatment area of the first glass substrate 56. Each peak in these figures corresponds with the absorption of one of a plurality of pulses from the light source 24 when the light 28 was at the fixed center point. FIGS. 15 and 16 were created by simulation and represent qualitative temperature evolutions for the low-speed and on-the-fly welding processes, respectively. Accordingly, the temperature units are listed as arbitrary units (au). In the temporal temperature evolution of the low-speed welding process, heat is rapidly accumulated within the first and second glass substrates 56, 60. The rapid heat accumulation is then followed by a rapid cooling of the first and second glass substrates 56, 60. This rapid heating and cooling that is associated with the low-speed welding process can result in a build-up of stress within the first glass substrate 56 and/or the second glass substrate 60. The built-up stress within the first glass substrate 56 and/or the second glass substrate 60 can lead to cracking within the first glass substrate 56 and/or the second glass substrate 60. By contrast, the temporal temperature evolution associated with the on-the-fly welding process exhibits a slow temperature accumulation from irradiation by the light 28 and heat diffusion from adjacent areas as they are exposed to the light 28. Arrow 212 denotes the direction of movement of the first and second glass substrates 56, 60 as a result of the movement of the translational stage 88. A maximum temperature of the temporal temperature evolution associated with the on-the-fly welding process is achieved proximate to a center point of an irradiate area of the first and second glass substrates 56, 60. Following the maximum temperature, the temperature gradually cools in a manner that is similar to the annealing process used in the manufacture of the first glass substrate 56 and the second glass substrate 60. The heating and cooling rate for the on-the-fly welding process is less than the heating and cooling rate of the low-speed welding process. The slower heating and cooling rate for the on-the-fly welding process is a result of heat accumulation from exposure to the light 28 and heat diffusion from adjacent processed areas that have already been exposed to the light 28. Accordingly, a smaller temperature gradient develops over the entire processing volume, with the exception of the current position of the light 28.

As can be seen in FIG. 16, a gradual shift in a baseline temperature of the processed area occurs, which aids in the decreased heating and cooling rates for the on-the-fly welding process. Compared to the temperature distribution simulated by the low-speed welding process (FIG. 15), the slower temperature change in heating and cooling stages of the on-the-fly welding process lead to an enlarged molten area, more efficient material mixing, and a thermal evolution or history that is similar to that exhibited during an annealing of the sample glass substrates. The lower thermal gradient was achieved over the entire processing volume other than localized spot. The temporal temperature evolution illustrated and described for the on-the-fly welding process results in less built-up stress within the first glass substrate 56 and/or the second glass substrate 60. Accordingly, the likelihood of cracking or other undesirable features can be mitigated while increasing throughput of the welding process. Additionally, the on-the-fly welding process offers a stable and reliable joining of the first and second glass substrates 56, 60 over a larger area when compared to the low-speed welding process. Further, the on-the-fly welding process described herein accomplishes these advantageous characteristics without the use of an additive layer positioned between the first and second glass substrates 56, 60.

Referring now to FIG. 17, direct welding or joining of high CTE and CTE mismatched glasses were performed without employing optical contact between the first and second glass substrates 56, 60. Prior to executing the welding or joining processes, the first and second glass substrates 56, 60 each went through ultrasonic cleaning, nitrogen drying, and were then stacked naturally (i.e., set onto one another). Air gaps of approximately 1-3.5 μm between the first and second glass substrates 56, 60 were observed by the presence of interference fringes. The vacuum chuck 64 was used to hold the first and second glass substrates 56, 60 in position without applying external pressure (i.e., no clamping). Predominant properties of typical glasses are listed in Table 2.

TABLE 2
Predominant Properties of Typical Glasses

| | Softening | CTE | |
|---|---|---|---|
| Glass | Temp. (° C.) | (ppm/° C.) | Basic Composition |
| Eagle XG ® | 985 | 3.15 | Alkaline Earth Boro- |
| | | | aluminosilicate |
| Gorilla | 912 | 8.69 | Sodium Alumino Phospho |
| Glass | | | Silicate |
| ULE ® | 1490 | 0 ± 0.03 | Titania Doped Fused Silica |
| Fused Silica | 1585 | 0.56 | Fused Silica |
| Soda-Lime | 721 | 9.1 | Soda-Lime |
| Borosilicate | 818 | 3.3 | Alkali Borosilicate |

Typically, welding of high CTE glasses using low translation velocity (e.g., 100 mm/s or less), such as the translation velocity used in the low-speed welding process described above, leads to glass ablation and cracking due to accumulated stress. The probability of glass ablation and cracking due to the accumulated stress is increased with the presence of the air gap. Defect formation was most prominently observed for glass combinations with high CTE values and mismatched CTE values. More specifically, due to the thermal expansion and contraction of the glass material, a larger residual stress was present and cracks were more common after executing the low-speed welding process on the high CTE and CTE mismatched glasses. To improve the chances of a successful welding or joining of the first and second glass substrates 56, 60, the difference in CTEs between the two glasses typically must be less than 5 ppm/° C. When the CTE mismatch is less than 5 ppm/° C., stable bonding without cracking is possible when employing the low-speed welding process of the present disclosure.

Utilizing the on-the-fly welding process, same and dissimilar glass combinations were joined without optical contact, including Eagle XG®/Eagle XG®, Gorilla Glass/Gorilla Glass, Gorilla Glass/Eagle XG®, and Gorilla Glass/Ultra-Low Expansion (ULE®). The greatest CTE mismatch in the aforementioned pairing was Gorilla Glass/ULE®, with a CTE mismatch of nearly 9 ppm/° C. After welding or joining, the fringes that are indicative of air gaps disappeared in the welding area, indicating the formation of reliable and solid bonding. In addition, the size of the gap 128 was gradually reduced at a start point of each weld line 160 and progressed to a solid bonding by an endpoint of each weld line 160.

Referring further to FIG. 17, fracture toughness, which is a material constant, was used to quantify the strength of the created bonding and compared with pristine bulk glasses. Fracture toughness, K_{IC}, represents the resistance of a material against the propagation of an already existing crack. The crack length measured from the crack opening test (see FIG. 7) can be related to the driving force for crack growth, the so-called Griffith energy release rate, G(a), which is given by Equation 5, below, where Δ is the thickness of the knife 180, a is the crack length, t is the thickness of the glass, and E is Young's modulus. In Equation 5, the subscript 1 denotes the second glass substrate 60 (top glass substrate) and the subscript 2 denotes the first glass substrate 56 (bottom glass substrate).

$${G}_{a} = \frac{3 {Δ}^{2}}{8 {a}^{4}} ( \frac{{E}_{1} {t}_{1}^{3} {E}_{2} {t}_{2}^{3}}{{E}_{1} {t}_{i}^{3} + {E}_{2} {t}_{2}^{3}} ) \qquad ( 5 )$$

The overall fracture toughness, K_{IC}, is given by Equation 6, below.

$${G}_{a} = \frac{{K}_{IC}^{2}}{E} \qquad ( 6 )$$

FIG. 17 summarizes the obtained fracture toughness for different glasses and glass combinations. The cross-hatched upper bars indicate the fracture toughness of the bulk material. The lower bars show the maximum achieved fracture toughness after welding for different glass combinations. The maximum fracture toughness measured by the crack opening test for the Eagle XG®/Eagle XG® glass combination was 0.78±0.24 MPa*m^{1/2}, which was 94% of the fracture toughness for bulk Eagle XG® glass. The maximum fracture toughness measured by the crack opening test for the Gorilla Glass/ULE® glass combination was 0.17 MPa*m^{1/2}, which was 24% of the fracture toughness for bulk Gorilla Glass. The maximum fracture toughness measured by the crack opening test for the Gorilla Glass/Eagle XG® glass combination was 0.51±0.24 MPa*m^{1/2}, which was 75% of the fracture toughness for bulk Gorilla Glass. The maximum fracture toughness measured by the crack opening test for the Gorilla Glass/Gorilla Glass combination was 0.47±0.10 MPa*m^{1/2}, which was 69% of the fracture toughness for bulk Gorilla Glass. By utilizing the on-the-fly welding process, the fracture toughness of the Eagle XG®/Eagle XG® glass combination increased by about 22% when compared with results that were obtained using the low-speed welding process at a translation velocity of 100 mm/s. This improvement in the joining of the Eagle XG®/Eagle XG® glass combination with the on-the-fly welding process achieved a maximum value of the fracture toughness that was close to the fracture toughness of the bulk material. The fracture toughness of dissimilar glass combinations, such as the Gorilla Glass/Eagle XG® glass combination, achieved a maximum value of the fracture toughness that was in between the maximum fracture toughness values obtained for the Eagle XG®/Eagle XG® glass combination and the Gorilla Glass/Gorilla Glass combination. This indicated that the resulted bonding strength is affected by both materials' properties, including, but not limited to, CTE, softening temperature, and viscosity.

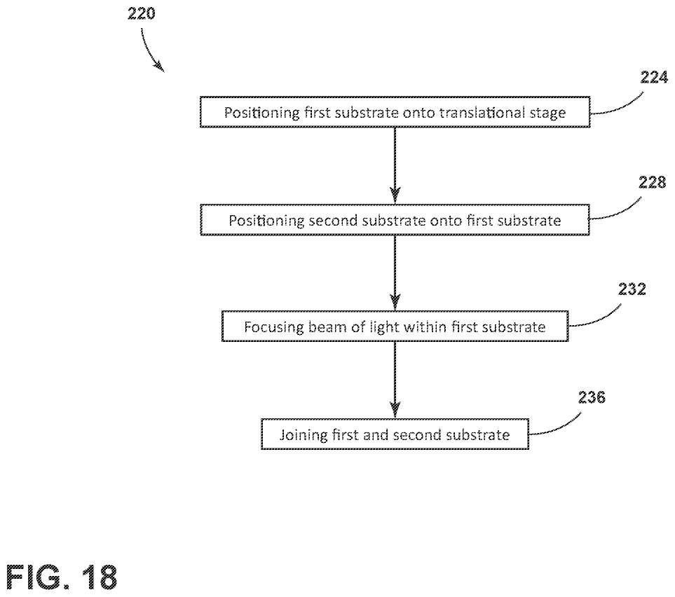

Referring now to FIG. 18, a method 220 of joining glass substrates is depicted. The method 220 includes step 224 of positioning the first glass substrate 56 onto the translational stage 88, with the first glass substrate 56 having the first bottom surface 104 and the first top surface 100. The method 220 also includes step 228 of positioning the second glass substrate 60 onto the first glass substrate 56 such that the second bottom surface 112 and the first top surface 100 are in direct contact with one another. However, a surface area of contact between the second bottom surface 112 and the first top surface 100 need not be an entirety of the surface area of the first glass substrate 56 and/or the second glass substrate 60. Rather, the surface area of contact between the second bottom surface 112 and the first top surface 100 can be a fraction of the entirety of the surface area of the first glass substrate 56 and/or the second glass substrate 60. The direct contact between the first and second glass substrates 56, 60 establishes the interface 140 between the first and second glass substrates 56, 60. The interface 140 between the first glass substrate 56 and the second glass substrate 60 defines the gap 128 with the height 132 extending between the first top surface 100 and the second bottom surface 112, with the height 132 of the gap 128 being up to about 10 μm. The method 220 also includes step 232 of focusing a beam of light 28 within the first glass substrate 56 proximate to the gap 128. The method 220 further includes step 236 of joining the first and second glass substrates 56, 60 to one another in a manner that closes the gap 128 as a result of the focusing of the beam of light 28 within the first glass substrate 56.

Referring again to FIG. 18, in various examples, the first glass substrate 56 can have a first coefficient of thermal expansion and the second glass substrate 60 can have a second coefficient of thermal expansion, with the first and second coefficients of thermal expansion differing by up to about 9 ppm/° C. For example, the first and second coefficients of thermal expansion can be identical or about the same. Alternatively, the first and second coefficients of thermal expansion can differ by about 1 ppm/° C., about 2 ppm/° C., about 3 ppm/° C., about 4 ppm/° C., about 5 ppm/° C., about 6 ppm/° C., about 7 ppm/° C., about 8 ppm/° C., about 9 ppm/° C., and/or combinations or ranges thereof. In some examples, the first and second glass substrates 56, 60 each exhibit a transmittance of at least about 90% at a wavelength of the beam of light 28. In such examples, the step 236 of joining the first and second glass substrates 56, 60 to one another in a manner that closes the gap 128 as a result of the focusing of the beam of light 28 within the first glass substrate 56 can include inducing an increase in temperature of the localized volume 148 of the first glass substrate 56 and the second glass substrate 60 as a result of the focusing a beam of light 28 within the first glass substrate 56 proximate to the gap 128. Additionally, in such examples, the localized volume 148 includes the plasma region 152 and/or the heat-affected zone 156. Further, in such examples, the plasma region 152 reaches a temperature sufficient to melt portions of the first and second glass substrates 56, 60 located within the plasma region 152. Still further, in such examples, the step 236 of joining the first and second glass substrates 56, 60 to one another in a manner that closes the gap 128 as a result of the focusing of the beam of light 28 within the first glass substrate 56 can include solidifying the melted portions of the first and second glass substrates 56, 60 located within the plasma region 152. Still further, in such examples, heat can be accumulated within the first and second glass substrates 56, 60 as a result of the induced increase in temperature of a localized volume of the first glass substrate 56 and the second glass substrate 60, with the heat that is accumulated being dissipated to a temperature below about 1,000° C. over a timeframe of between about 1 millisecond and about 30 milliseconds following exposure to the beam of light 28. For example, the heat can be dissipated to a temperature below about 1,000° C. over a timeframe of about 1 millisecond, about 5 milliseconds, about 10 milliseconds, about 15 milliseconds, about 20 milliseconds, about 25 milliseconds, about 30 milliseconds, and/or combinations or ranges thereof. In various examples, the temperature dissipation following exposure to the beam of light 28 occurs in the absence of external heat sources (e.g., a hot plate or oven) other than the light source 24. Said another way, other than ambient environmental conditions (e.g., room temperature of about 20° C.), the light 28 from the light source 24 can provide the sole source of heating to the first and second glass substrates 56, 60.

Referring further to FIG. 18, the method 220 can include adjusting a position of the translational stage 88 along the first axis 204 such that the first glass substrate 56 and the second glass substrate 60 are moved relative to the beam of light 28, thereby propagating the joining of the first and second glass substrates 56, 60 to one another. In some examples, the method 220 can also include rastering the beam of light 28 back-and-forth along the second axis 208 such that a position of the beam of light 28 is moved relative to the first glass substrate 56 and the second glass substrate 60. The first axis 204 and the second axis 208 can be angularly offset from one another. For example, the first axis 204 and the second axis 208 can be angularly offset from one another by up to about ninety degrees (90°). In various examples, the beam of light 28 focused within the first glass substrate 56 proximate to the gap 128 can be from a pulsed laser. In such an example, rastering the beam of light 28 back-and-forth along the second axis 208 such that a position of the beam of light 28 is moved relative to the first glass substrate 56 and the second glass substrate 60 can results in a pulse overlap between sequential pulses from the pulsed laser to define the weld line 160. In various examples, the pulse overlap can be up to about 99%. For example, the pulse overlap can be zero percent such that sequential pulses do not overlap. Alternatively, the pulse overlap can be up to about 10%, up to about 20%, up to about 30%, up to about 40%, up to about 50%, up to about 60%, up to about 70%, up to about 80%, up to about 90%, up to about 99%, and/or combinations or ranges thereof. In some examples, the step of adjusting a position of the translational stage 88 along the first axis 204 such that the first glass substrate 56 and the second glass substrate 60 are moved relative to the beam of light 28 results in the line overlap between adjacent weld lines 160 (e.g., the first weld line 160A and the second weld line 160B). In various examples, the line overlap can be up to about 99%. For example, the line overlap can be zero percent such that sequential pulses do not overlap. Alternatively, the pulse overlap can be up to about 10%, up to about 20%, up to about 30%, up to about 40%, up to about 50%, up to about 60%, up to about 70%, up to about 80%, up to about 90%, up to about 99%, and/or combinations or ranges thereof. In some examples, the focal point 136 of the beam of light 28 has a diameter that is up to about 10 μm. For example, the focal point 136 of the beam of light 28 can have a diameter that is about 1 μm, about 2 μm, about 3 μm, about 4 μm, about 5 μm, about 6 μm, about 7 μm, about 8 μm, about 9 μm, about 10 μm, and/or combinations or ranges thereof. In various examples, the method 220 can include positioning the focal point 136 of the beam of light 28 between about 40 μm and about 90 μm away from the interface 140 between the first and second glass substrates 56, 60.

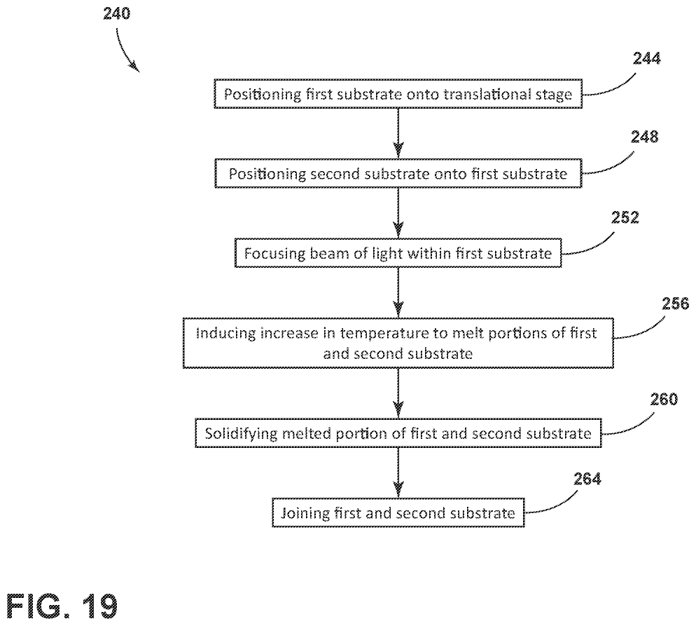

Referring to FIG. 19, a method 240 of joining glass substrates includes step 244 of positioning the first glass substrate 56 onto the translational stage 88, with the first glass substrate 56 having the first bottom surface 104 that is proximate to the translational stage 88 and the first top surface 100 that is opposite to the first bottom surface 104. The method 240 also includes step 248 of positioning the second glass substrate 60 onto the first glass substrate 56 such that the second bottom surface 112 of the second glass substrate 60 and the first top surface 100 of the first glass substrate 56 are in direct contact with one another. However, as with the method 220 discussed with regard to FIG. 18, a surface area of contact between the second bottom surface 112 and the first top surface 100 need not be an entirety of the surface area of the first glass substrate 56 and/or the second glass substrate 60. Rather, the surface area of contact between the second bottom surface 112 and the first top surface 100 can be a fraction of the entirety of the surface area of the first glass substrate 56 and/or the second glass substrate 60. The direct contact between the first and second glass substrates 56, 60 establishes the interface 140 between the first glass substrate 56 and the second glass substrate 60. The method further includes step 252 of focusing a beam of light 28 within the first glass substrate 56 proximate to the interface 140 between the first glass substrate 56 and the second glass substrate 60. In various examples, the first and second glass substrates 56, 60 each exhibit a transmittance of at least about 90% at a wavelength of the beam of light 28. The method 240 also includes step 256 of inducing an increase in temperature of the localized volume 148 of the first glass substrate 56 and the second glass substrate 60 as a result of the focusing a beam of light 28 within the first glass substrate 56 proximate to the interface 140 between the first glass substrate 56 and the second glass substrate 60. The localized volume 148 includes the plasma region 152 and/or the heat-affected zone 156. The plasma region 152 can reach a temperature sufficient to melt portions of the first and second glass substrates 56, 60 located within the plasma region 152. The method further includes step 260 of solidifying the melted portions of the first and second glass substrates 56, 60 located within the plasma region 152. The method also includes step 264 of joining the first and second glass substrates 56, 60 as a result of the melting and solidifying of the portions of the first and second glass substrates 56, 60 located within the plasma region 152.

Referring again to FIG. 19, the interface 140 between the first glass substrate 56 and the second glass substrate 60 defines the gap 128 with the height 132 that extends between the first top surface 100 and the second bottom surface 112. The height 132 of the gap 128 can be up to about 10 μm. The first glass substrate 56 can have a first coefficient of thermal expansion and the second glass substrate 60 can have a second coefficient of thermal expansion. In various examples, the first and second coefficients of thermal expansion differ by up to about 9 ppm/° C. In some examples, heat is accumulated within the first and second glass substrates 56, 60 as a result of the induced increase in temperature of the localized volume 148 of the first glass substrate 56 and the second glass substrate 60. In such an example, the heat that is accumulated can be dissipated to a temperature below about 1,000° C. over a timeframe of between about 1 millisecond and about 30 milliseconds following exposure to the beam of light 28. For example, the heat can be dissipated to a temperature below about 1,000° C. over a timeframe of about 1 millisecond, about 5 milliseconds, about 10 milliseconds, about 15 milliseconds, about 20 milliseconds, about 25 milliseconds, about 30 milliseconds, and/or combinations or ranges thereof. In various examples, the temperature dissipation following exposure to the beam of light 28 occurs in the absence of external heat sources (e.g., a hot plate or oven) other than the light source 24. Said another way, other than ambient environmental conditions (e.g., room temperature of about 20° C.), the light 28 from the light source 24 can provide the sole source of heating to the first and second glass substrates 56, 60. In various examples, the method 240 can also include adjusting a position of the translational stage 88 along the first axis 204 such that the first glass substrate 56 and the second glass substrate 60 are moved relative to the beam of light 28, thereby propagating the joining of the first and second glass substrates 56, 60 to one another. In some examples, the method 240 can further include rastering the beam of light 28 back-and-forth along the second axis 208 such that a position of the beam of light 28 is moved relative to the first glass substrate 56 and the second glass substrate 60. The first axis 204 and the second axis 208 can angularly offset from one another. In some examples, the first axis 204 and the second axis 208 are angularly offset from one another by up to about ninety degrees (90°). In various examples, the beam of light 28 focused within the first glass substrate 56 proximate to the gap 128 can be from a pulsed laser. In such an example, the rastering the beam of light 28 back-and-forth along the second axis 208 such that the position of the beam of light 28 is moved relative to the first glass substrate 56 and the second glass substrate 60 results in a pulse overlap between sequential pulses from the pulsed laser to define the weld line 160. In some examples, the pulse overlap can be up to about 99%. In various examples, the step of adjusting the position of the translational stage 88 along the first axis 204 such that the first glass substrate 56 and the second glass substrate 60 are moved relative to the beam of light 28 results in a line overlap between adjacent weld lines 160 (e.g., the first weld line 160A and the second weld line 160B). In some examples, the line overlap can be up to about 99%. In various examples, the method 240 can include positioning the focal point 136 of the beam of light 28 between about 40 μm and about 90 μm away from the interface 140 between the first and second glass substrates 56, 60. In some examples, the focal point 136 of the beam of light 28 can have a diameter that is up to about 10 μm.

It will be apparent to those skilled in the art that various modifications and variations can be made without departing from the spirit or scope of the claims.

What is claimed is:

1. A method of joining glass substrates, comprising the steps of:
coupling a first glass substrate to a second glass substrate, wherein the first glass substrate has a first bottom surface and a first top surface that is opposite to the first bottom surface, wherein the second glass substrate is positioned onto the first glass substrate such that a second bottom surface of the second glass substrate and the first top surface of the first glass substrate are in direct contact with one another, wherein the direct contact between the first and second glass substrates establish an interface between the first glass substrate and the second glass substrate, wherein the interface between the first glass substrate and the second glass substrate defines a gap with a height that extends between the first top surface and the second bottom surface, and wherein the height of the gap is up to about 10 μm;
positioning the first glass substrate onto a translational stage such that the first bottom surface is proximate to the translational stage;
focusing a beam of light within the first glass substrate proximate to the gap; and
joining the first and second glass substrates to one another in a manner that closes the gap as a result of the focusing of the beam of light within the first glass substrate.

2. The method of claim 1, wherein the first glass substrate has a first coefficient of thermal expansion and the second glass substrate has a second coefficient of thermal expansion, and wherein the first and second coefficients of thermal expansion differ by up to about 9 ppm/° C.

3. The method of claim 1, wherein the first and second glass substrates each exhibit a transmittance of at least about 90% at a wavelength of the beam of light.

4. The method of claim 3, wherein the step of joining the first and second glass substrates to one another in a manner that closes the gap as a result of the focusing of the beam of light within the first glass substrate comprises:
inducing an increase in temperature of a localized volume of the first glass substrate and the second glass substrate as a result of the focusing a beam of light within the first glass substrate proximate to the gap, wherein the localized volume comprises at least one area chosen from a plasma region and a heat-affected zone, and wherein the plasma region reaches a temperature sufficient to melt portions of the first and second glass substrates located within the plasma region; and
solidifying the melted portions of the first and second glass substrates located within the plasma region.

5. The method of claim 4, wherein heat is accumulated within the first and second glass substrates as a result of the induced increase in temperature of a localized volume of the first glass substrate and the second glass substrate, and wherein the heat that is accumulated is dissipated to a temperature below about 1,000° C. over a timeframe of between about 1 millisecond and about 30 milliseconds following exposure to the beam of light.

6. The method of claim 1, further comprising:
adjusting a position of the translational stage along a first axis such that the first glass substrate and the second glass substrate are moved relative to the beam of light, thereby propagating the joining of the first and second glass substrates to one another.

7. The method of claim 6, further comprising:
rastering the beam of light back-and-forth along a second axis such that a position of the beam of light is moved relative to the first glass substrate and the second glass substrate, wherein the first axis and the second axis are angularly offset from one another.

8. The method of claim 7, wherein the beam of light focused within the first glass substrate proximate to the gap is from a pulsed laser, wherein the step of rastering the beam of light back-and-forth along a second axis such that a position of the beam of light is moved relative to the first glass substrate and the second glass substrate results in a pulse overlap between sequential pulses from the pulsed laser to define a weld line, and wherein the pulse overlap is up to about 99%.

9. The method of claim 8, wherein the step of adjusting a position of the translational stage along a first axis such that the first glass substrate and the second glass substrate are moved relative to the beam of light results in a line overlap between adjacent weld lines, and wherein the line overlap is up to about 99%.

10. The method of claim 7, wherein the first axis and the second axis are angularly offset from one another by up to about ninety degrees (90°).

11. The method of claim 1, wherein a focal point of the beam of light has a diameter that is up to about 10 μm.

12. The method of claim 11, further comprising:
positioning the focal point of the beam of light between about 40 μm and about 90 μm away from the interface between the first and second glass substrates.

13. A method of joining glass substrates, comprising the steps of:
coupling a first glass substrate to a second glass substrate, wherein the first glass substrate has a first bottom surface and a first top surface that is opposite to the first bottom surface, wherein the second glass substrate is positioned onto the first glass substrate such that a second bottom surface of the second glass substrate and the first top surface of the first glass substrate are in direct contact with one another, wherein the direct contact between the first and second glass substrates establish an interface between the first glass substrate and the second glass substrate;
positioning the first glass substrate onto a translational stage, wherein the first bottom surface is proximate to the translational stage;
focusing a beam of light within the first glass substrate proximate to the interface between the first glass substrate and the second glass substrate, wherein the first and second glass substrates each exhibit a transmittance of at least about 90% at a wavelength of the beam of light;
inducing an increase in temperature of a localized volume of the first glass substrate and the second glass substrate as a result of the focusing a beam of light within the first glass substrate proximate to the interface between the first glass substrate and the second glass substrate, wherein the localized volume comprises at least one area chosen from a plasma region and a heat-affected zone, and wherein the plasma region reaches a temperature sufficient to melt portions of the first and second glass substrates located within the plasma region;
solidifying the melted portions of the first and second glass substrates located within the plasma region; and
joining the first and second glass substrates as a result of the melting and solidifying of the portions of the first and second glass substrates located within the plasma region.

14. The method of claim 13, wherein the interface between the first glass substrate and the second glass substrate defines a gap with a height that extends between the first top surface and the second bottom surface, and wherein the height of the gap is up to about 10 μm.

15. The method of claim 13, wherein the first glass substrate has a first coefficient of thermal expansion and the second glass substrate has a second coefficient of thermal expansion, and wherein the first and second coefficients of thermal expansion differ by up to about 9 ppm/° C.

16. The method of claim 13, wherein heat is accumulated within the first and second glass substrates as a result of the induced increase in temperature of a localized volume of the first glass substrate and the second glass substrate, and wherein the heat that is accumulated is dissipated to a temperature below about 1,000° C. over a timeframe of between about 1 millisecond and about 30 milliseconds following exposure to the beam of light.

17. The method of claim 16, further comprising:
adjusting a position of the translational stage along a first axis such that the first glass substrate and the second glass substrate are moved relative to the beam of light, thereby propagating the joining of the first and second glass substrates to one another; and
rastering the beam of light back-and-forth along a second axis such that a position of the beam of light is moved relative to the first glass substrate and the second glass substrate, wherein the first axis and the second axis are angularly offset from one another, and wherein the first axis and the second axis are angularly offset from one another by up to about ninety degrees (90°).

18. The method of claim 17, wherein the beam of light focused within the first glass substrate proximate to the gap is from a pulsed laser, wherein the step of rastering the beam of light back-and-forth along a second axis such that a position of the beam of light is moved relative to the first glass substrate and the second glass substrate results in a pulse overlap between sequential pulses from the pulsed laser to define a weld line, and wherein the pulse overlap is up to about 99%.

19. The method of claim 18, wherein the step of adjusting a position of the translational stage along a first axis such that the first glass substrate and the second glass substrate are moved relative to the beam of light results in a line overlap between adjacent weld lines, and wherein the line overlap is up to about 99%.

20. The method of claim 13, further comprising:
positioning a focal point of the beam of light between about 40 μm and about 90 μm away from the interface between the first and second glass substrates, wherein the focal point of the beam of light has a diameter that is up to about 10 μm.
